(19) United States
(12) Patent Application Publication
(10) Pub. No.: US 2017/0193452 A1
(43) Pub. Date: Jul. 6, 2017

(54) JOB REFERRAL SYSTEM

(71) Applicant: LinkedIn Corporation, Mountain View, CA (US)

(72) Inventors: Jian Wang, Los Altos, CA (US); Rahul Aggarwal, Milpitas, CA (US); Parul Jain, Cupertino, CA (US); Harpaul Singh Sambhi, Mountain View, CA (US)

(21) Appl. No.: 14/988,543

(22) Filed: Jan. 5, 2016

(51) Int. Cl. G06Q 10/10; G06Q 50/00; G06F 17/30

(52) U.S. Cl. CPC G06Q 10/1053; G06F 17/3053; G06F 17/30554; G06F 17/30867; G06Q 50/01

(57) ABSTRACT

A referral system is provided with an on-line social network system. The referral system accesses a member profile representing an employee of a certain company and a target job posting representing a job opening at the same company. The referral system analyzes respective profiles of the member's connections in relation to the target job posting. For each connected member profile, the referral system generates a presentation score with respect to the job posting. The presentation score generated reflects likelihood that that particular employee refers a candidate represented by the connected member profile for the job represented by the target job posting and is used to determine which connected member profiles are to be presented to the employee.

### TECHNICAL FIELD

This application relates to the technical fields of software and/or hardware technology and, in one example embodiment, to system and method to facilitate a referral process in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An on-line social network system also maintains information about various companies, as well as job postings. An on-line social network system may provide a service for providing information about job postings to members.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to facilitate a referral process in an on-line social network system may be implemented;

FIG. 2 is block diagram of a system to facilitate a referral process in an on-line social network system, in accordance with one example embodiment;

FIG. 3 is a flow chart illustrating a method to facilitate a referral process in an on-line social network system, in accordance with an example embodiment;

FIG. 4 is a User Interface screen for presenting an employee with a selected set of the employee's connections in the on-line social network system and an invitation to refer one of these selected connections for a specific job at their company, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to facilitate a referral process in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.). The profile of a member may also include information about the member's current and past employment, such as company identifications, professional titles held by the associated member at the respective companies, as well as the member's dates of employment at those companies.

A member profile is also associated with social links that indicate the associated member's connection to other members of the social network. Any two members of an on-line social network may indicate their mutual willingness to be “connected” in the context of the social network, in that they can view each other's profiles, profile recommendations and endorsements for each other and otherwise be in touch via the social network. Members who are connected in the context of a social network may be termed each other's “connections” and their respective profiles are associated with respective connection links indicative of these two profiles being connected. Two members may be referred as each other's first degree connections when their respective profiles include connection links that indicate that these two profiles are connected. When a member (let's call her member A) is not connected to another member (let's call him member B), but is connected to member C, who is connected to member B, member A and member B are considered each other's second degree connections in the on-line social network. A member's connections, both first degree connections and higher degree connections are refereed to, collectively, as the member's network.

As mentioned above, an on-line social network system also maintains information about various companies, as well as so-called job postings. A job posting, for the purposes of this description is an electronically stored entity that includes information that an employer may post with respect to a job opening. The information in a job posting may include, e.g., the industry, job position, required and/or desirable skills, geographic location of the job, the name of a company, etc. Member profiles and job postings are represented in the on-line social network system by feature vectors. The features in the feature vectors may represent, e.g., a job industry, a professional field, a job title, a company name, professional seniority, geographic location, etc.

In one embodiment, the on-line social network system includes or is in communication with a so-called recommendation engine that may be part of or in communication with the on-line social network system. A recommendation engine may be configured to determine whether a member profile represents a potential good candidate for a job advertised by a particular job posting, and, if so, present that job posting to the member, e.g., via an email, on the news feed page of the member, as a pop-up message when the member accesses the on-line social network system using a browser application of a mobile app, in response to a job search request initiated by the member within the on-line social network system, etc. A recommendation engine may be provided in the form of a binary classifier that can be trained using a set of training data. The set of training data can be constructed using historical data, such as, e.g., data that indicates whether a certain job posting presented to a certain member resulted in that member applying for that job, whether the member viewed the job posting, shared it with other members, etc. A trained binary classifier may be used to generate, for a (member profile, job posting) pair, a value indicative of how well the job presented in the posting is suited for the member represented by the member profile. This value may be referred to as a relevance score and may be calculated as cosine similarity between the respective feature vectors of the member profile and the job posting from a (member profile, job posting) pair. A job posting may be recommended to a member if, e.g., the associated relevance score is greater than a predetermined threshold value.

When a job position opens up at a company, it may be beneficial to solicit referrals for the job from people who are currently employed at the company. A potential challenge, however, is that an employee is not necessarily aware of what jobs the company is trying to fill, and, even if presented with information about a specific job opening, some employees may find it difficult to recall all or any of the people they know that could be interested in or sufficiently qualified to apply for that job. A technological solution to these challenges is a computer-implemented referral system that utilizes data available in the on-line social network system. A referral system may be part of or in communication with the on-line social network system and may also include or be in communication with a recommendation engine. In some embodiments, a recommendation engine may include or be in communication with a referral system. For the purposes of this description, a system comprising modules that, collectively, provide functionality of a recommendation engine and a referral system, is referred to as a referral system.

In one embodiment, a referral system is configured to generate a selected set of the employee's connections in the on-line social network system for presentation to the employee together with an invitation to refer one of these selected connections for a specific job at their company. It will be noted that, while an organization, at which employment may be offered, may be an entity other than a company, the term “company” is used for the purposes of this description to refer to any organization, at which employment may be offered.

The referral system accesses a member profile representing an employee of a certain company and a job posting representing a job opening at the same company (a target job posting). The referral system then analyzes respective profiles of the member's connections (connected member profiles) in relation to the target job posting. For each connected member profile, the referral system generates a so-called presentation score with respect to the job posting. The presentation score generated for a connected member profile reflects likelihood that that particular employee refers a candidate represented by the connected member profile for the job represented by the target job posting. The presentation score for a connected member profile with respect to the target job posting may be expressed as P(C|E, J), where J is a job posting, C is a connected member profile, and E is the member profile representing an employee of a company indicated in the job posting J. The presentation score P(C|E, J) is calculated as shown in Equation (1) below.

P(C|E,J)=P(C|J)P(C|E) Equation 1

As expressed in Equation (1), the presentation score is a combination of the value P(C|J) in reflecting fitness of a candidate represented by the connected member profile C for the job represented by the target job posting J and the value P(C|E) reflecting connection strength between the employee member profile and the connected member profile C.

The value P(C|J) is a relevance scores that can be calculated by a recommendation engine for the connected member profile C in relation to the target job represented by the job posting J. When relevance scores are being used to determine a presentation score for a connected member profile with respect to the target job posting, the relevance score P(C|J) is termed a fitness score (to indicate how fit is the candidate for the job).

In some embodiments, the referral system is configured to generate a presentation scores only for those connected member profiles that satisfy certain criteria. For example, the referral system may exclude from consideration those connected member profiles that represent members who are employed at the same company as the subject employee. The referral system may also exclude from consideration those connected member profiles that represent members who have been employed at the target organization for less than a certain period of time (e.g., less than six months) or for greater than a certain period of time (e.g., greater than five years).

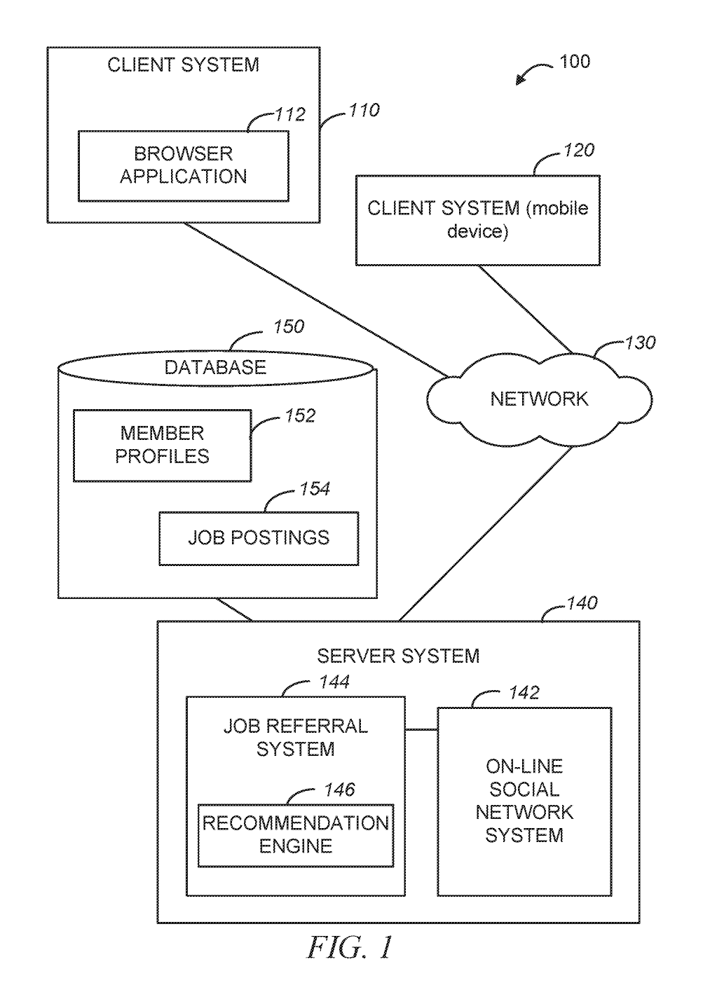

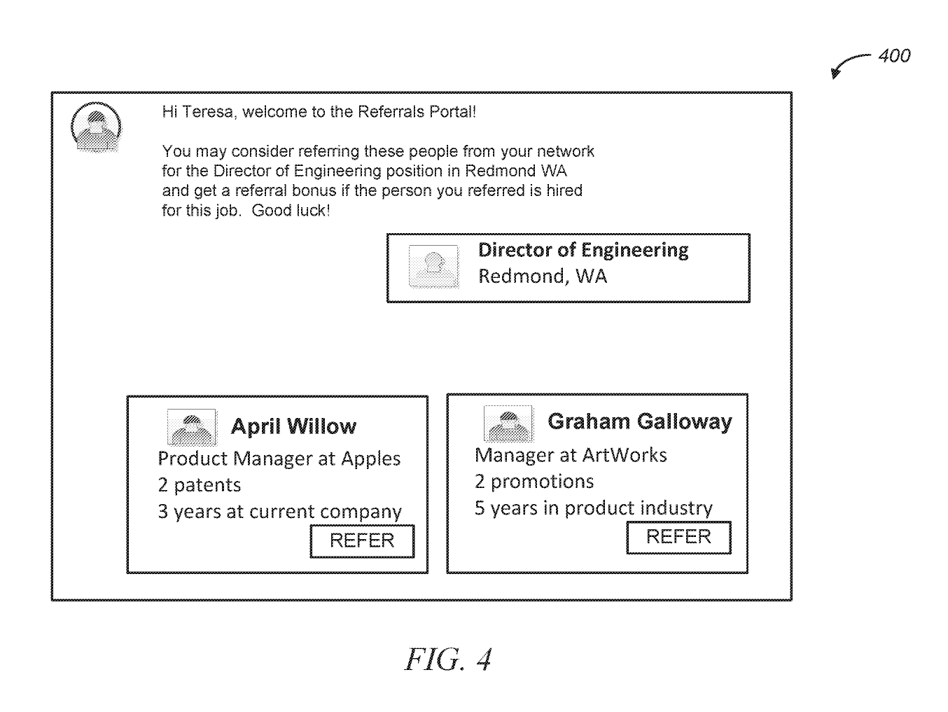

The referral system uses respective presentation scores generated for the connected member profiles to determine which of these profiles are to be selected for inclusion into a referral user interface for presentation to the employee. For example, a certain number or a certain percentage of connected member profiles that have the highest presentation scores, as compared to respective presentation scores generated for other connected member profiles, are used in generating a referral user interface for presentation to the subject employee. An example referral user interface screen 400 for presenting an employee with an invitation to refer one or more of their connections for a particular job available at the employee's organization is illustrated in FIG. 4. An example referral system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores job postings 154. It will be noted that, in some embodiments, the database 150 is considered to be part of the on-line social network system 142.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a referral system 144 and a recommendation engine 146. It will be noted that, in some embodiments, the referral system 144 and the recommendation engine 146 are considered to be part of the on-line social network system 142. The recommendation engine 146 is configured to match member profiles with respective job postings stored in the database 150, as mentioned above.

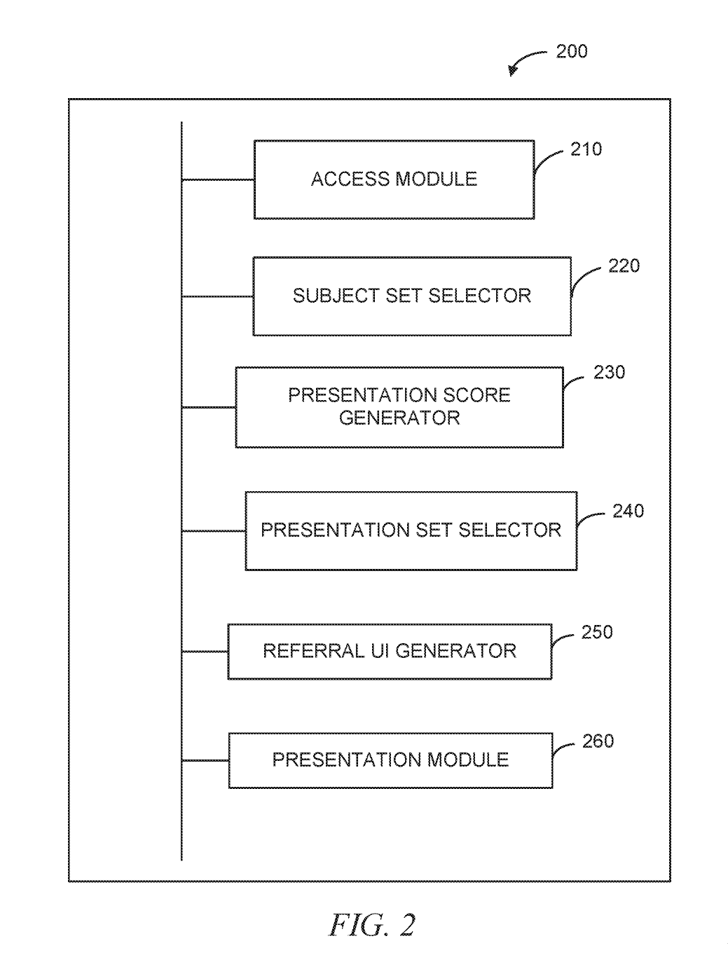

The referral system 144 may be configured to generate a set of candidate member profiles for presentation to a member of the on-line social network system who is an employee of a particular target organization (or company) with a suggestion, explicit or implicit, that the member may wish to refer one or more of their connections represented by the presented candidate member profiles for a specific job at their company, as already described above. In one embodiment, the referral system 144 accesses a member profile representing an employee of a certain company and also accesses a job posting that represents a job at that company. The referral system 144 also accesses connected member profiles representing connections of the employee in the on-line social network system 142 and, for each connected member profile generates a presentation score that reflects that that particular employee refers a candidate represented by the connected member profile for that specific job represented by the target job posting. The referral system 144 uses respective presentation scores generated for the connected member profiles are used to determine which connected member profiles are to be selected for inclusion into a referral UI for presentation to the employee, e.g., on a display device of the client system 110 or on a display device of the client system 120. The presentation scores may be calculated using Equation (1) shown above. An example referral system 144 is illustrated in FIG. 2.

FIG. 2 is a block diagram of a system 200 to facilitate a referral process in an on-line social network system 142 of FIG. 1. As shown in FIG. 2, the system 200 includes an access module 210, a subject set selector 220, a presentation score generator 230, a presentation set selector 240, a referral user interface generator 250, and a presentation module 260. The access module 210 is configured to access, from the database 150 of FIG. 1, a target job posting representing a job at a target organization and an employee member profile representing an employee of the target organization in the on-line social network system 142 of FIG. 1.

The subject set selector 220 is configured to access, from the database 150 of FIG. 1, a set of connected member profiles in the on-line social network system, each profile in the set of connected member profiles including a link indicating connection relationship with the employee member profile. In some embodiments, the subject set selector 220 may be configured to consider only those connected member profiles that include an indication that the associated member has worked at the target organization no less than a certain period of time no less than 6 months or a year) and no longer that a certain period of time (e.g., not longer than five or six years).

The presentation score generator 230 is configured to generate, to generate, for each connected member profile from the set of connected member profiles, a respective presentation score. A presentation score for a connected member profile reflects a likelihood that the employee refers the person represented by the connected member profile for the target job posting and is generated based on (1) fitness of a candidate represented by the connected member profile for the job represented by the target job posting and (2) connection strength between the employee member profile and the connected member profile. In one embodiment, the presentation score generator 230 calculates the respective presentation scores using Equation (1) described above. As explained above, the presentation score for a connected member profile may be calculated by combining the fitness value and the connection strength value. The fitness value may be calculated for the connected member profile and the job posting as cosine similarity between respective feature vectors of the connected member profile and the target job posting. The connection strength value may be calculated for the employee member profile and the connected member profile as cosine similarity between respective feature vectors of the employee member profile and the connected member profile. The presentation score generator 240 may be configured to assign respective weights to the fitness value, the fitness value and the connection strength value, and to use these respective weights in combining these values for generating a presentation score. As mentioned above, the features in the feature vectors may represent, e.g., a job industry, a professional field, a job title, a company name, professional seniority, geographic location, etc.

The presentation set selector 240 is configured to select a presentation set of connected member profiles based on the respective presentation scores generated for the set of connected member profiles. For example, a certain number or a certain percentage of connected member profiles s with the highest presentation score may be selected for presentation to the employee using a UI screen such as, e.g., illustrated in FIG. 4 described above.

The referral user interface generator 250 is configured to generate a referral user interface, such as, e.g., illustrated in FIG. 4, comprising representation of profiles from the presentation set of connected member profiles. The referral user interface generator 250 is configured to provide a referral visual control to be displayed as associated with a presentation of a member profile from the presentation set of connected member profiles. The referral visual control (e.g., a “Refer” button) is actionable to communicate a referral message to the on-line social network system 142, where the referral message indicates a referral of a candidate represented by the member profile for the job represented by the target job posting.

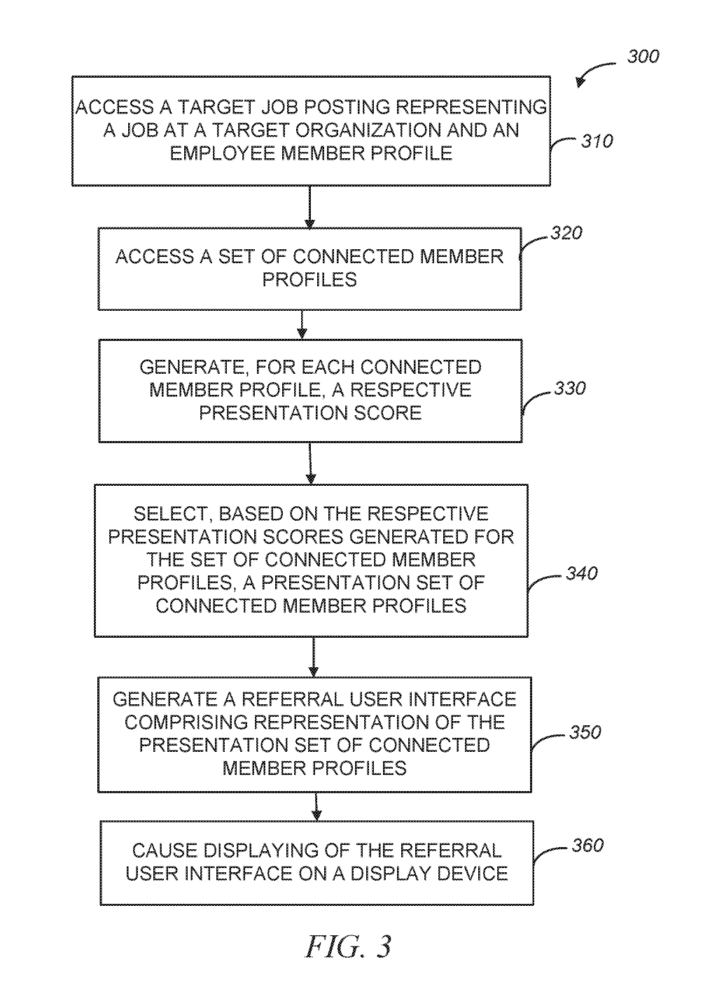

The presentation module 260 is configured to cause displaying of the referral user interface on a display device, e.g., on a display device of the client system 110 of FIG. 1 or on a display device of the client system 120 of FIG. 1. Some operations performed by the system 200 may be described with reference to FIG. 3.

FIG. 3 is a flow chart of a method 300 to facilitate a referral process in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 accesses, from the database 150 of FIG. 1, an employee member profile representing an employee of a target organization in the on-line social network system 142 of FIG. 1 and a target job posting representing a job at the target organization. The subject set selector 220 of FIG. 2 accesses, from the database 150, a set of connected member profiles at operation 320. Each profile in the set of connected member profiles includes a link indicating connection relationship with the employee member profile. At operation 330, the presentation score generator 230 generates, for each connected member profile from the set of connected member profiles, respective presentation scores using the methodology and the equation described above. A presentation score generated for a connected member profile reflects a likelihood that the employee refers the person represented by the connected member profile for a job represented by the target job posting. At operation 340, the presentation set selector 240 selects a presentation set of connected member profiles based on the respective presentation scores. At operation 350, the referral user interface generator 250 generates a referral user interface, such as, e.g., illustrated in FIG. 4. The presentation module 260 causes displaying of the referral user interface on a display device, e.g., on a display device of the client system 110 of FIG. 1 or on a display device of the client system 120 of FIG. 1, at operation 360.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

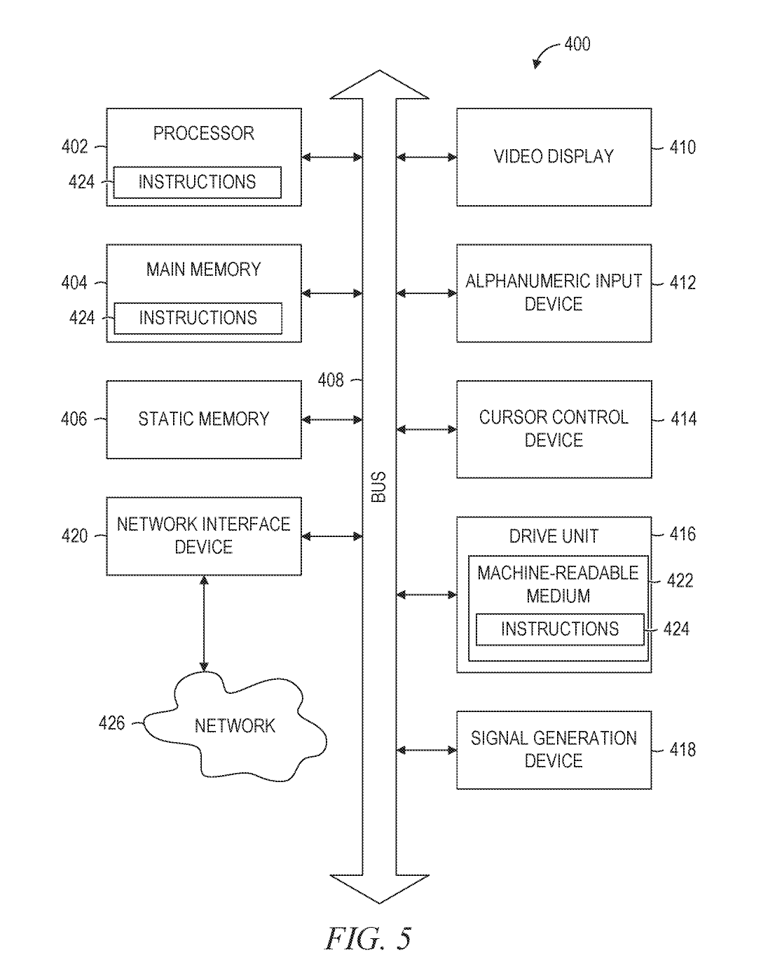

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to facilitate a referral process in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a target job posting representing a job at a target organization;
accessing an employee member profile representing an employee of the target organization in an on-line social network system;
accessing a set of connected member profiles in the on-line social network system, each profile in the set of connected member profiles including a link indicating connection relationship with the employee member profile;
using at least one processor, for each connected member profile from the set of connected member profiles, generating a respective presentation score, wherein the generating of a presentation score for a connected member profile from the set of connected member profiles comprises:
calculating a fitness value for the connected member profile and the target job posting as cosine similarity between respective feature vectors of the connected member profile and the target job posting,
calculating a connection strength value for the employee member profile and the connected member profile as cosine similarity between respective feature vectors of the employee member profile and the connected member profile, and
combining the fitness value and the connection strength value, the presentation score reflecting both the fitness value for the connected member profile and the target job posting and the connection strength value for the employee member profile and the connected member profile;
based on the respective presentation scores generated for the set of connected member profiles, selecting a presentation set of connected member profiles;
generating a referral user interface comprising representation of the presentation set of connected member profiles; and
causing displaying of the referral user interface on a display device.

2.-3. (canceled)

4. The method of claim 1, wherein a feature from the respective feature vectors of the employee member profile and the connected member profile represents a professional title.

5. (canceled)

6. The method of claim 1, wherein the generating of the presentation score for the connected member profile comprises assigning respective weights to the fitness value and the connection strength value.

7. The method of claim 1, wherein the generating of the referral user interface comprises including, in the referral user interface a referral visual control to be displayed as associated with a presentation of a connected member profile from the presentation set of connected member profiles, the referral visual control actionable to communicate a referral message to the on-line social network system, the referral message indicating a referral of a candidate represented by the connected member profile for the job at the target organization.

8. The method of claim 1, wherein each profile from the set of connected member profiles represent a member who is currently employed at a company that is different from the target organization.

9. The method of claim 1, wherein each profile from the set of connected member profiles indicate a duration of current employment being greater than a first threshold value.

10. The method of claim 1, wherein each profile from the set of connected member profiles indicate a duration of current employment being less than a second threshold value.

11. A computer-implemented system comprising:
an access module, implemented using at least one processor, to access a target job posting representing a job at a target organization and an employee member profile representing an employee of the target organization in an on-line social network system;
a subject set selector, implemented using at least one processor, to access a set of connected member profiles in the on-line social network system, each profile in the set of connected member profiles including a link indicating connection relationship with the employee member profile;
a presentation score generator, implemented using at least one processor, to generate, for each connected member profile from the set of connected member profiles, a respective presentation score, wherein the generating of a presentation score for a connected member profile from the set of connected member profiles comprises:
calculating a fitness value for the connected member profile and the target job posting as cosine similarity between respective feature vectors of the connected member profile and the target job posting,
calculating a connection strength value for the employee member profile and the connected member profile as cosine similarity between respective feature vectors of the employee member profile and the connected member profile, and
combining the fitness value and the connection strength value, the presentation score reflecting both the fitness value for the connected member profile and the target job posting and the connection strength value for the employee member profile and the connected member profile;
a presentation set selector, implemented using at least one processor, to select a presentation set of connected member profiles based on the respective presentation scores generated for the set of connected member profiles;
a referral user interface generator, implemented using at least one processor, to generate a referral user interface comprising representation of the presentation set of connected member profiles; and
a presentation module, implemented using at least one processor, to cause displaying of the referral user interface on a display device.

12.-13. (canceled)

14. The system of claim 11, wherein a feature from the respective feature vectors of the employee member profile and the connected member profile represents a professional title.

15. (canceled)

16. The system of claim 11, wherein the presentation score generator is to assign respective weights to the fitness value and the connection strength value.

17. The system of claim 11, wherein the referral user interface generator is to include, in the referral user interface a referral visual control to be displayed as associated with a presentation of a connected member profile from the presentation set of connected member profiles, the referral visual control actionable to communicate a referral message to the on-line social network system, the referral message indicating a referral of a candidate represented by the connected member profile for the job at the target organization.

18. The system of claim 11, wherein each profile from the set of connected member profiles represent a member who is currently employed at a company that is different from the target organization.

19. The system of claim 11, wherein each profile from the set of connected member profiles indicate a duration of current employment being greater than a first threshold value and less than a second threshold value.

20. A machine-readable non-transitory storage medium having instruction data executable by a machine to cause the machine to perform operations comprising:
accessing a target job posting representing a job at a target organization;
accessing an employee member profile representing an employee of the target organization in an on-line social network system;
accessing a set of connected member profiles in the on-line social network system, each profile in the set of connected member profiles including a link indicating connection relationship with the employee member profile;
for each connected member profile from the set of connected member profiles, generating a respective presentation score, wherein the generating of a presentation score for a connected member profile from the set of connected member profiles comprises:
calculating a fitness value for the connected member profile and the target job posting as cosine similarity between respective feature vectors of the connected member profile and the target job posting,
calculating a connection strength value for the employee member profile and the connected member profile as cosine similarity between respective feature vectors of the employee member profile and the connected member profile, and
combining the fitness value and the connection strength value, the presentation score reflecting both the fitness value for the connected member profile and the target job posting and the connection strength value for the employee member profile and the connected member profile;
based on the respective presentation scores generated for the set of connected member profiles, selecting a presentation set of connected member profiles;
generating a referral user interface comprising representation of the presentation set of connected member profiles; and
causing displaying of the referral user interface on a display device.
